(19) United States
(12) Patent Application Publication
(10) Pub. No.: US 2003/0231891 A1
(43) Pub. Date: Dec. 18, 2003

(54) Optical transmitter and a controlling method thereof

(75) Inventors: Hiroshi Kuzukami, Kawasaki (JP); Kazuhiro Suzuki, Kawasaki (JP); Rumiko Tashiro, Sapporo (JP); Kakuji Inoue, Sapporo (JP); Hiroshi Yamada, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/347,472

(22) Filed: Jan. 21, 2003

(30) Foreign Application Priority Data
Jun. 14, 2002 (JP) 2002-174611

(51) Int. Cl. H04B 10/04

(52) U.S. Cl. 398/198; 398/195

(57) ABSTRACT

An optical transmitter is capable of constantly operating at an optimal operating point, even when a polarization angle varies, which is realized by an operation processing device controlling such that a predetermined range of an input-and-output characteristic of a modulator is scanned in order to obtain a bias voltage point that gives an optimal operation range, and an operation point controlling circuit controlling the operation range by a feedback control with the detected bias voltage point as a starting point.

### BACKGROUND OF THE INVENTION

1. Field of the Invention

The present invention generally relates to an optical transmitter equipped with a Mach-Zehnder type modulator and a controlling method thereof, and especially relates to an optical transmitter equipped with a Mach-Zehnder type modulator, input-and-output characteristics of which are effectively used, and a controlling method thereof.

2. Description of the Related Art

In optical transmitters used in optical fiber communications systems, a direct modulation method is often used, wherein electric current supplied to a semiconductor laser is modulated by a data signal. However, the direct modulation method tends to generate a large amount of dynamic wavelength changes (chirping) in the optical signal that is output, due to wavelength distribution in the optical fiber, as transmission speed becomes high. Therefore, it is considered that the direct modulation method is not suitable for long-distance transmissions. Then, an optical transmitter equipped with a Mach-Zehnder type modulator, which, in principle, generates little chirping is being studied.

In order to attain stable operations of an optical fiber communications system that deploys the optical transmitter equipped with the Mach-Zehnder type optical modulator, it is necessary to cope with a problem resulting from an operating point drift of the optical modulator, as explained below.

FIG. 1 is an example of a block diagram of a conventional optical transmitter equipped with a Mach-Zehnder type optical modulator. The conventional optical transmitter includes a luminous source 1 consisting of a semiconductor laser, etc., a Mach-Zehnder type optical modulator 2, a signal electrode 3 of the optical modulator 2, an optical detection circuit 4, a modulator driving circuit 5, a terminator 6, an operating point control circuit 7, a low frequency superposing circuit 8, a low frequency oscillator 9, bias-tees 10 and 11, an inductor L, and capacitors C, the inductor L and the capacitors C constituting the bias-tees.

The Mach-Zehnder type optical modulator 2 (the modulator 2) includes a circuit pattern of an optical waveguide for branching and combining. The modulator 2 also includes the signal electrode 3 and a grounding electrode for applying an electric field to the branched optical waveguide. Further, to an end of the signal electrode 3, a driving signal is applied, and to the other end, the terminator 6 is connected, which is a 50-ohm resistor, through the capacitor C of the bias-tee 11.

In an optical modulator such as configured as the optical modulator 2, an incident light that has a constant light intensity is divided into two branched lights, having equal intensity, by a divider, and the branched lights are transmitted through two separate waveguides. The branched lights are later combined by a coupler, and the combined light is output. If a predetermined driving voltage is applied to the signal electrode 3 of one of the waveguides, a refractive index, i.e., propagation speed, of the waveguide is changed, and a phase difference in reference to the other waveguide is generated, the other side not having a voltage applied. Here, when the phase difference is equal to 2nπ, where n=0, 1, 2, and so on, the optical output intensity becomes the greatest, and when the phase difference is equal to (2n+1)π, the optical output intensity becomes the lowest. Thus, in the optical transmitter equipped with the Mach-Zehnder type optical modulator, light intensity modulation can be performed on the constant-intensity light from the luminous source such as a semiconductor laser. The light intensity modulation performed in this manner is less susceptible to chirping, which is the problem with the direct modulation method, and therefore, is suitable for high speed and long-distance transmission.

The input-and-output characteristics (operating characteristic curve) of the Mach-Zehnder type optical modulator are periodic. Therefore, effective modulation can be performed by biasing the predetermined driving voltage to voltages V0 and V1 so that the minimum and maximum intensity values, respectively, on the operating characteristic curve are obtained, according to a logical value of an incoming signal. Here, a voltage difference between the biased driving voltages, one giving the minimum value and the other giving the maximum value, is called Vπ. The biased driving voltages are subject to a drift (operating point drift) that arises from temperature changes, time elapses, etc. When the operating point drift occurs, a quenching ratio of the output light is degraded. If a ratio of the driving voltages V0/V1 is set to a fixed value, the degradation of the quenching ratio cannot be cured. Rather, when the operating point drift occurs, the amount of which is expressed by dV, the driving voltages V0 and V1 are required to be set at V0+dV and V1+dV, respectively.

To achieve this, a low frequency signal from the low frequency oscillator 9 is provided to the low frequency superposing circuit 8 such that the low frequency signal is superimposed on a driving signal from the modulator driving circuit 5, which is a several Gbps signal. The low frequency superimposed signal is provided to the signal electrode 3 through the capacitor C of the bias-tee 10, and the low frequency superimposed signal modulates the light from the luminous source 1. The output light modulated by the optical modulator 2 is converted to an electric signal by the optical detection circuit 4, which performs synchronous detection in sync with the low frequency signal from the low frequency oscillator 9. Since the operating point of the optical modulator 2 can be controlled, the operating point control circuit 7 provides a bias voltage to the signal electrode 3 through the inductor L of the bias-tee 11 such that the magnitude of the low frequency signal component detected by the synchronous detection becomes the smallest. A feedback control such as this realizes stable modulation characteristics against an operating point drift (refer to JP,2000-162563,A filed by the inventors of the present invention).

A light that propagates in a waveguide is separable into two different polarization modes, namely, TM (Transverse magnetic) mode and TE (Transverse Electric) mode. Since refractive indices of a waveguide are different for the two modes, input-and-output characteristics of an optical modulator change with the polarization angle of an incident light. Supposing there is no attenuation in the waveguide, the input-and-output characteristics of an optical modulator are expressed as follows.

P_{TM}=sin²(π/2*V/V_{TMπ})

P_{TE}=sin²(π/2*V/V_{TEπ}+Φ)

where, P_{TM} is an optical output intensity when the incident light is in TM mode, P_{TE} is an optical output intensity when the incident light is in TE mode, V is a driving voltage, V_{TMπ} and V_{TEπ} represent a difference of two voltages, one giving the largest value and the other giving the smallest value in TM mode and TE mode, respectively, and Φ represents a phase difference between the input-and-output characteristics of TM mode and TE mode.

The input-and-output characteristics of the optical modulator for TM mode incidence and TE mode incidence are as shown in FIG. 2 from an actual measurement, where V_{TMπ}=3.0V, V_{TEπ}=8.8V, and Φ=0.

As shown in FIG. 3, the incident light provided to the optical modulator contains TM mode and TE mode components, which is expressed by a vector that has a phase angle Φ.

When the light containing the TM mode component and the TE mode component is input, an optical output intensity P is expressed as follows, according to the input-and-output characteristics.

P=(P_{TM}²+P_{TE}²)^{1/2},

where P represents the optical output intensity of the light containing the TE mode and TM mode components.

Usually, the TM mode component is far greater than the TE mode component in a constant-intensity light that is input to an optical modulator. Therefore, P is approximately equal to P_{TM}, and the input-and-output characteristics of an optical modulator become as shown in FIG. 4.

Here, the minimum value Pout_min of the optical output intensity of an operation curve becomes 0 (refer to a point c of FIG. 5). Further, when an ideal bias is obtained by a feedback control, the quenching ratio Ex expressed by the following formula becomes infinity (refer to FIG. 5).

Ex=10 log(Pout_max/Pout_min)=infinity(dB)

However, under an influence of the luminous source, the modulator, a fiber connection (splicing) between the luminous source and the modulator, etc., the polarization angle is variable, with a TE mode component being generated. As the result thereof, the phase angle Φ becomes more than 0 degrees (refer to the FIG. 3). Then, the input-and-output characteristics of the optical modulator are influenced by the TE mode component, and the TM mode quenching characteristic is degraded. An example of the situation at that time is shown in FIG. 6. That is, local minimum points a and b do not reach zero.

At this time, the modulation characteristics of the modulator become as shown in FIG. 7.

That is, when a first local minimum output intensity Pout_min1 is ideally 0.000, the corresponding first quenching ratio 1 is infinity dB. When the input-and-output characteristics of the modulator are affected by the influence of the TE mode component like the above, the local minimum of optical output intensity cannot reach 0, and the quenching ratio is degraded. For example, if a second minimum output intensity Pout_min2 is 0.065, the corresponding second quenching ratio 2 becomes 11.9 dB, and, if a third minimum output intensity Pout_min3 is 0.060, the corresponding third quenching ratio 3 becomes 12.2 dB.

As described above, when the polarization angle of the incident light to the modulator varies in the luminous source, the modulator, the fiber connection (splicing) between the luminous source and the modulator, etc., the local minimum of the optical output intensity fluctuates according to a frequency of the TE mode component, and the dynamic range of the modulated light wave depends on a bias voltage point. That is, although the conventional controlling method compensates for an operating point drift by locking onto the local maximum and the local minimum values, the locking is performed on an arbitrary cycle of the operation curve that is periodic. That is, when the locking is performed by chance on a cycle wherein the dynamic range of the modulation light wave is not desirable (for example, the cycle including the point a of FIG. 6), characteristics of the optical transmitter are degraded. In such a case, especially the quenching ratio and an output stoppage suppression ratio are adversely affected.

To solve the above problem, screening of luminous sources and modulators, improvements in accuracy of splicing, and inserting a polarization filter in the incident end of the modulator are considered to minimize the variation of the polarization angle, that is, to minimize the TE mode component. However, these methods are highly likely to lead to a cost rise, an increase in dimensions of the optical transmitter, etc.

### SUMMARY OF THE INVENTION

Accordingly, it is a general object of the, present invention to provide an optical transmitter that can obtain an ideal dynamic range of an optical modulator even when the polarization angle of an incident light to a Mach-Zehnder type optical modulator varies, and a controlling method thereof, which substantially obviate one or more of the problems caused by the limitations and disadvantages of the related art.

Features and advantages of the present invention will be set forth in the description that follows, and in part will become apparent from the description and the accompanying drawings, or may be learned by practice of the invention according to the teachings provided in the description. Objects as well as other features and advantages of the present invention will be realized and attained by the optical transmitter and the controlling method thereof particularly pointed out in the specification in such full, clear, concise, and exact terms as to enable a person having ordinary skill in the art to practice the invention.

To achieve these and other advantages and in accordance with the object of the present invention, as embodied and broadly described herein, the invention provides:

a Mach-Zehnder type optical modulator that modulates the optical intensity of an incident light by a bias input, and outputs the modulated light,

input-and-output characteristic scanning means for scanning a predetermined portion of the input-and-output characteristics of the Mach-Zehnder type optical modulator by changing the bias input, and

optimal bias voltage point determining means for determining a bias voltage point that gives an optimal dynamic range of the Mach-Zehnder type optical modulator from the scanning result of the input-and-output characteristic scanning means.

According to the configuration described above, even if the optimal range of operation becomes available only within a limited range of the input-and-output characteristic cycles due to variation of the incident light polarization, the limited range is detectable and the optimal bias voltage point that gives the optimal dynamic range of the Mach-Zehnder type optical modulator is obtained from the scanning result of the input-and-output characteristic scanning means. This is achieved by the input-and-output characteristic scanning means scanning the predetermined portion of the input-and-output characteristics of the Mach-Zehnder type optical modulator

### BRIEF DESCRIPTION OF THE DRAWINGS

FIG. 1 is an example of a block diagram of a conventional optical transmitter;

FIG. 2 shows an example of an operation curve of an optical modulator;

FIG. 3 is for explaining characteristics of an incident light to an optical modulator;

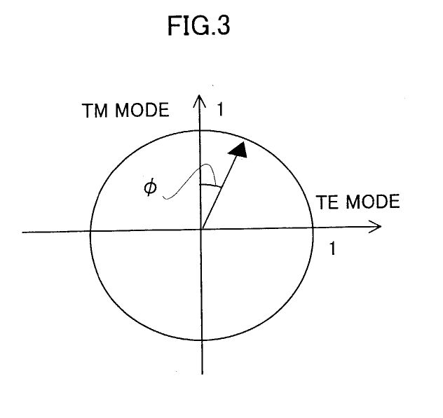

FIG. 4 shows an example of an operation curve of an optical modulator when a TM mode component is dominant;

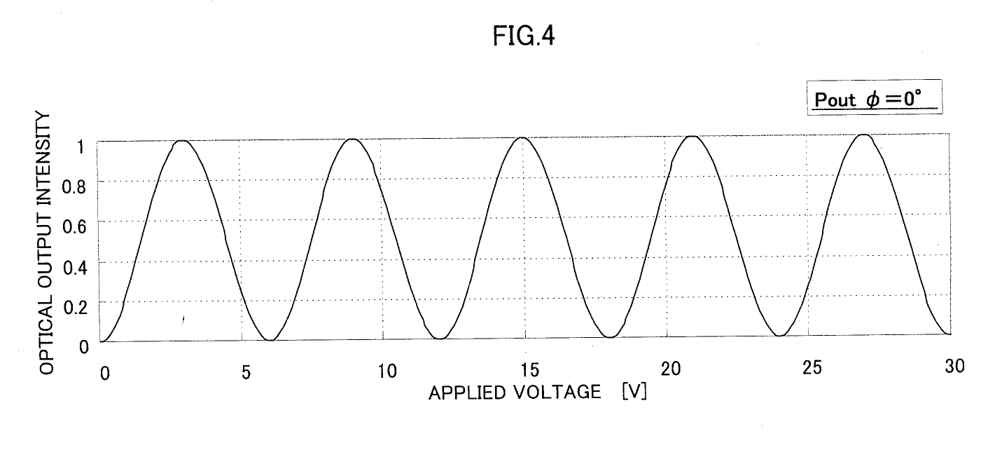

FIG. 5 is for explaining a quenching ratio of an optical modulator when the TM mode component is dominant;

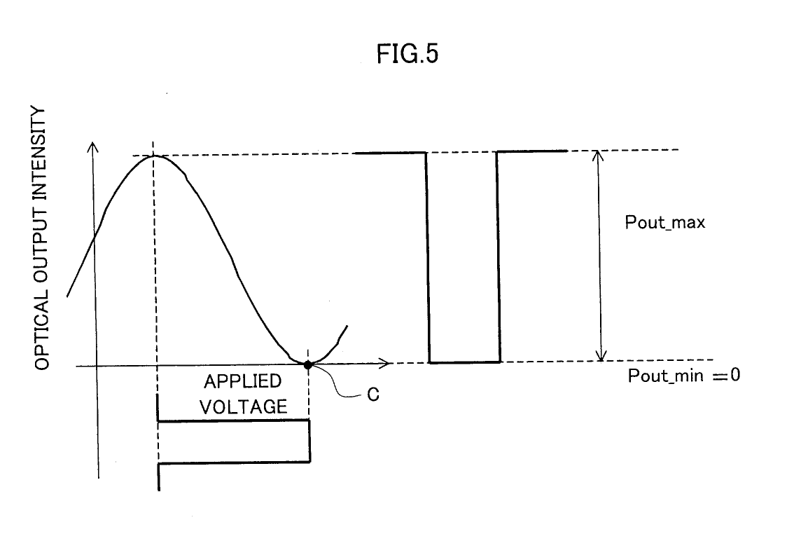

FIG. 6 shows an example of an operation curve of an optical modulator when there is a variation of polarization of the incident light;

FIG. 7 is for explaining a quenching ratio of an optical modulator when there is a variation of polarization of the incident light;

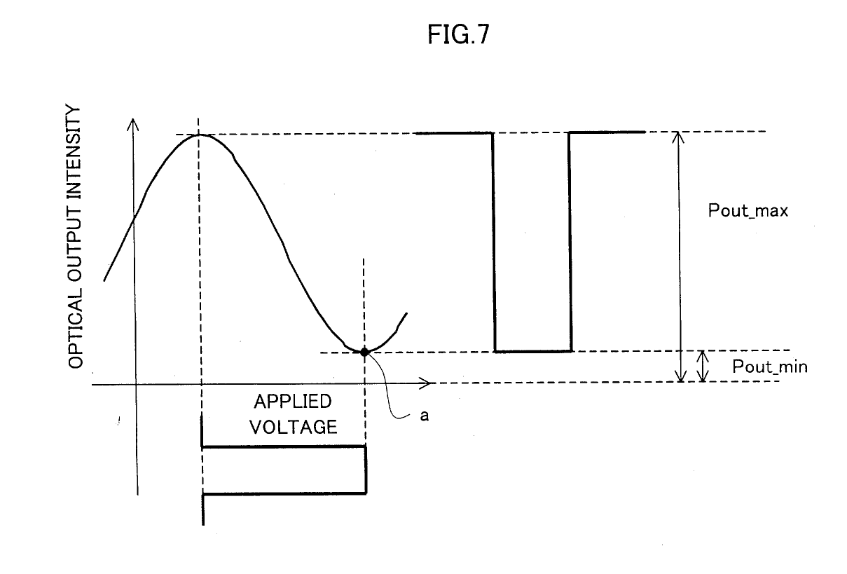

FIG. 8 is a block diagram showing a conceptual configuration of an embodiment of the present invention;

FIG. 9 is a circuit block diagram of an optical transmitter of the first embodiment of the present invention;

FIG. 10 is for explaining a sweep operation of a bias voltage for acquiring input-and-output characteristics of the optical modulator of the first embodiment of the present invention;

FIG. 11 is a drawing (part 1) for explaining a selection method for selecting a step width when acquiring the input-and-output characteristics of the optical modulator of the first embodiment of the present invention;

FIG. 12 is a drawing (part 2) for explaining a selection method for selecting a step width when acquiring the input-and-output characteristics of the optical modulator of the first embodiment of the present invention; and

FIG. 13 is a circuit block diagram of the optical transmitter of the second embodiment of the present invention.

### DESCRIPTION OF THE PREFERRED EMBODIMENTS

In the following, embodiments of the present invention will be described with reference to the accompanying drawings.

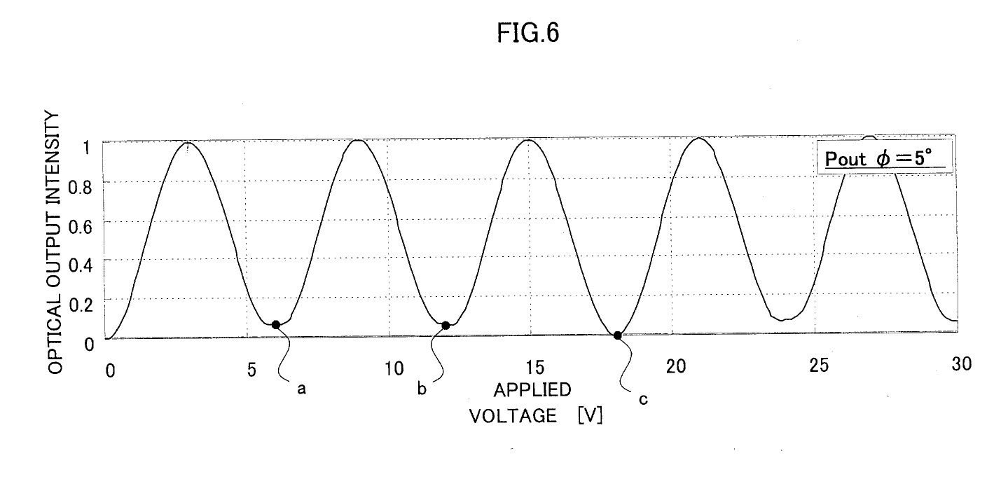

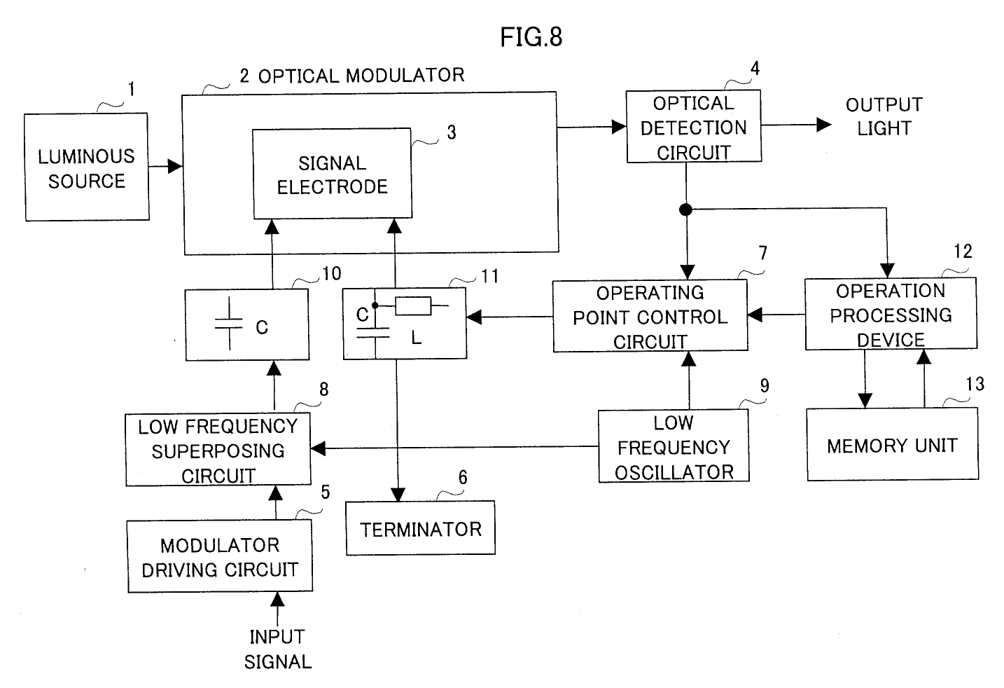

First, the fundamental concept of the present invention is explained. When the polarization angle of an incident light provided to a Mach-Zehnder type optical modulator varies, the local minimum value of the optical output intensity changes in response to the frequency of the TE mode component contained in the incident light, and the dynamic range of the modulated light depends on a bias voltage point (refer to the FIG. 6). Therefore, if an optimal bias voltage point for each cycle of the TE mode component can be correctly determined, characteristics of an optical transmitter will not be degraded. A configuration for correctly choosing the optimal bias voltage point for each cycle of the TE mode component is explained with reference to FIG. 8.

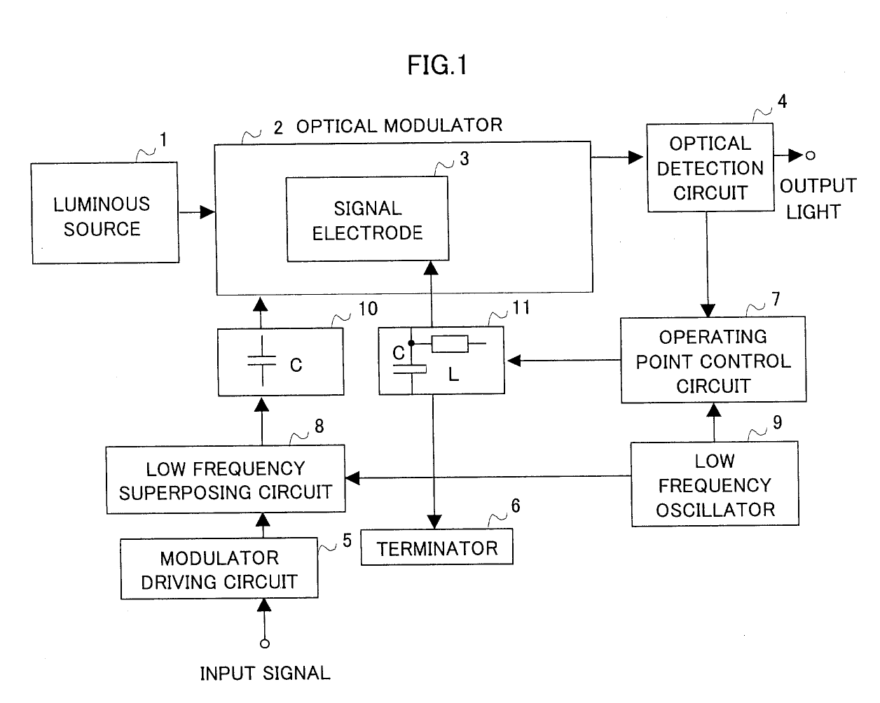

In FIG. 8, the same reference numbers are attached for the same elements as shown in FIG. 1. First, a luminous source 1 provides a constant-intensity light (an incident light) to a Mach-Zehnder type modulator 2 (the modulator 2). An operation processing device 12 gives a predetermined bias voltage to a signal electrode 3 of the modulator 2 through an operating point control circuit 7. Then, an output light, which is a modulated optical signal, having an optical intensity according to input-and-output characteristics of the modulator 2 is obtained from the modulator 2, and the modulated light which is output is detected by an optical detection circuit 4, which converts the modulated optical signal into an electric signal that represents the input-output characteristics of the modulator 2. Then, a bias voltage at which a local minimum light intensity is obtained is determined from the input-and-output characteristics of the modulator 2. The bias voltage serves as a starting point of the conventional feedback control, such that an operating point drift is coped with, as is the case with the conventional technology.

In the following, embodiments of the present invention are explained.

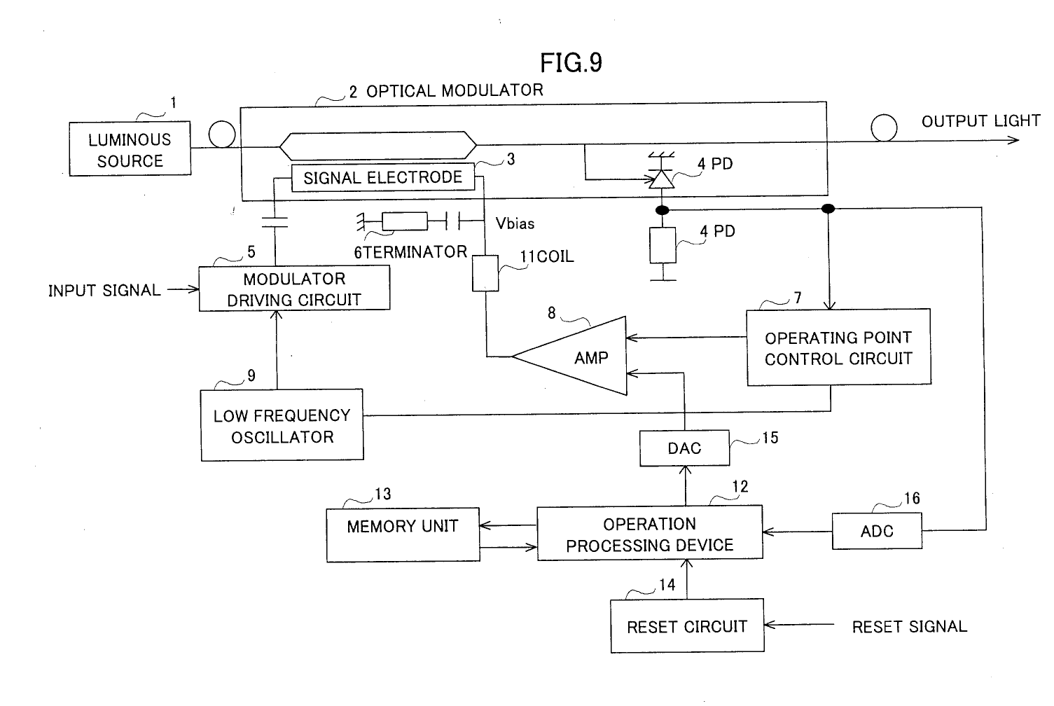

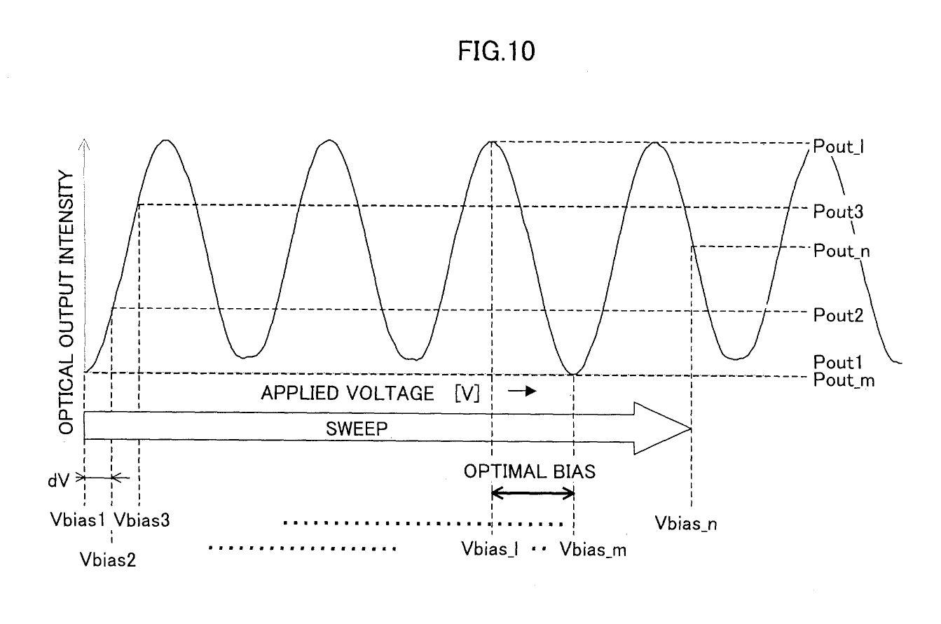

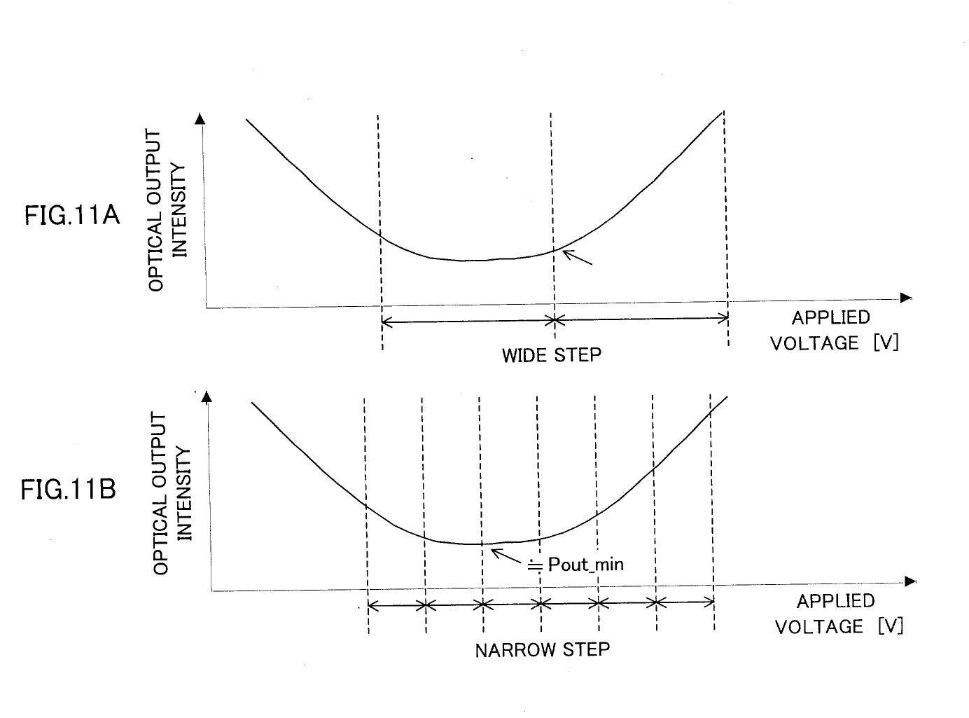

The first embodiment of the present invention is explained with reference to FIG. 9, FIG. 10, and FIG. 11.

FIG. 9 is a block diagram showing a configuration of the optical transmitter of the first embodiment of the present invention. The same reference numbers are given to the same elements as shown in FIG. 8, and explanations thereof are not repeated.

The optical transmitter includes a luminous source 1 that further includes a semiconductor laser, etc., a Mach-Zehnder type optical modulator 2 (the modulator 2), a signal electrode 3 for inputting a modulating signal to the modulator 2, a photo diode (PD) 4 serving as an optical detection circuit, a modulator driving circuit 5, a terminator 6, an operating point control circuit 7, an amplifier AMP for applying a bias voltage to the modulation signal, a low frequency oscillator 9, a coil 11 for a bias-tee, an operation processing device 12, such as CPU, a memory unit 13, a reset circuit 14, a D/A converter 15, and an A/D converter 16.

Here, a constant-intensity light is input to the modulator 2 from the luminous source 1, and the operation processing device 12 gives a predetermined bias voltage Vbias1 to the signal electrode 3 through the amplifier AMP and the coil 11. In this manner, an output light having an optical intensity according to the input-and-output characteristics of the modulator 2 is obtained from the modulator 2. Furthermore, the output light is detected by the optical detection circuit 4, and is converted to an electric signal. The electric signal is converted to a digital signal by the A/D converter (ADC) 16, and provided to the operation processing device 12. The electric signal that is digitized represents an output optical intensity value Pout1 that corresponds to the bias voltage.

Next, the operation processing device 12 gives a bias voltage Vbias2, which is a voltage higher than the bias voltage Vbias1 by dV. Vbias2 is provided to the signal electrode 3, and an output having an optical intensity value Pout2 is acquired in the same manner as described above. This operation is repeated n times, that is, the bias voltage is incrementally shifted, that is, sweeping of the voltage is performed, and the output having optical intensity values Pout1, Pout2, . . . and Poutn are acquired for each bias voltage. The bias voltages and corresponding output optical intensity values are stored in the memory unit 13 (refer to FIG. 10).

Since a Mach-Zehnder type optical modulator has the characteristic that (Vπ in TM mode)×3 is approximately equal to (Vπ in TE mode), the optimal bias voltage point (for example, a bias voltage point corresponding to a cycle including the point c in FIG. 6) is detectable by measuring three cycles of Vπ in the TM mode. In this manner, the three cycles are made the sweeping range of the bias voltage.

From the input-and-output characteristics acquired in this manner, a bias range between Vbias_l (letter “l”) and Vbias_m that gives the largest dynamic range, i.e., Pout_l (letter “l”) and Pout_m, is selected from a range between Pout_{—}1 (number “1”) and Pout_n (refer to FIG. 10). The bias range is made the starting point of the feedback control.

Here, the feedback refers to an operation wherein a standard voltage corresponding to the bias voltage point is provided to the amplifier AMP through the D/A converter 15; the operating point control circuit 7 controls the voltage applied to the amplifier AMP making reference to the standard voltage; the value of Vbias to be applied to the signal electrode 3 is fine tuned; and in this manner, the operating point drift detected by the optical detection circuit 4 is compensated for.

In addition, when the reset circuit 14 detects a predetermined reset signal that is generated upon the power supply starting, switching of the incident light to the modulator, a switching, etc., the reset circuit 14 resets the operation processing device 12 such that the bias voltages are swept, the input-and-output characteristics of the modulator 2 are acquired, and the optimal bias voltage point is obtained (updating operation of the optimal bias voltage point) as above, again.

Detection accuracy when acquiring the input-and-output characteristics by sweeping the bias voltage affects the quenching ratio characteristics of the modulator 2. In other words, if a sampling step width of the sweeping is too wide, an accurate bias voltage that gives the local minimum point cannot be correctly detected (compare a graph marked (a) of FIG. 11 with a graph marked (b) of FIG. 11). Therefore, in order to acquire sufficient detection accuracy, the sampling step width of sweeping is desirably determined from the following two viewpoints.

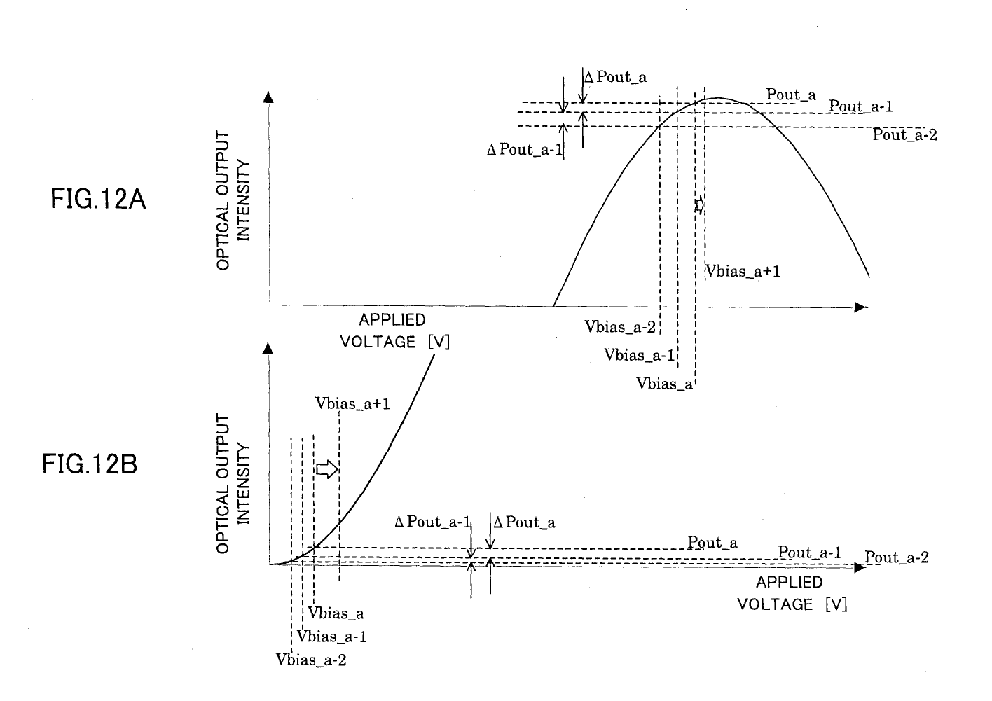

Namely, (1) the finer the sampling step width of sweeping is, the higher the accuracy is (refer to FIG. 11 at (a) and (b)), and (2) time required of sweeping can be shortened if fine sampling steps are taken only when necessary, i.e., near the local maximum and the local minimum points (refer to FIG. 12 at (a) and (b)).

Relative to the viewpoint (1) above, a step width required for obtaining a desired accuracy is obtained from Table 1 below, which is obtained from the following formula that defines the optical intensity when the TM mode component is input.

P_{TM}=sin²(π/2*V/V_{TMπ})

TABLE 1

| | Detection | Converted | Required | |
|---|---|---|---|---|
| | accuracy | quenching | step width | |
| # | (%) | ratio (dB) | dV (V) | Remarks |
| 1 | 15.1 | 8.2 | 1.52 | ITU-T G957 |
| | | | | STM-16 |
| | | | | standards |
| 2 | 10.0 | 10.0 | 1.23 | ITU-T G957 |
| | | | | STM-1, 4 |
| | | | | standards |
| 3 | 6.3 | 12.0 | 0.94 | |
| 4 | 4.0 | 14.0 | 0.77 | |
| 5 | 2.5 | 16.0 | 0.60 | |
| 6 | 1.6 | 18.0 | 0.48 | |
| 7 | 1.0 | 20.0 | 0.38 | |
| 8 | 0.1 | 30.0 | 0.1 | |

Table 1 gives, among other things, a required sampling step width that corresponds to a desired quenching ratio.

Relative to the viewpoint (2), the technique to vary the sweep step width is explained. FIG. 12 is an enlarged input-and-output characteristic curve of the modulator. Here, the light intensity of the optical output is expressed as Pout_a at a certain bias voltage point Vbias_a, Pout_a−1 at a bias voltage point Vbias_a−1 that precedes Vbias_a, and Pout_a−2 at a bias voltage point Vbias_a−2 that precedes Vbias_a−1. Then, absolute differences of the light intensity values are obtained. Namely,

ΔPout_{—}a−1=|(Pout_{—}a−1)−(Pout_{—}a−2)|

ΔPout_{—}a=|(Pout_{—}a)−(Pout_{—}a−1)|

If ΔPout_a−1<ΔPout_a, the sweeping operation is moving from the local maximum/minimum point, therefore, the sweeping step width is increased. If, to the contrary, ΔPout_a−1>ΔPout_a, the sweeping operation is moving toward the local maximum/minimum point, therefore, the sweeping step width is reduced. Further, if ΔPout_a−1≈ΔPout_a, the step width is maintained and the sweep is continued.

As described above, the number of data acquisition points becomes fewer by controlling the sampling step width than in the case where a uniform step width is used, the time required of sweeping is shortened, and less memory capacity is required.

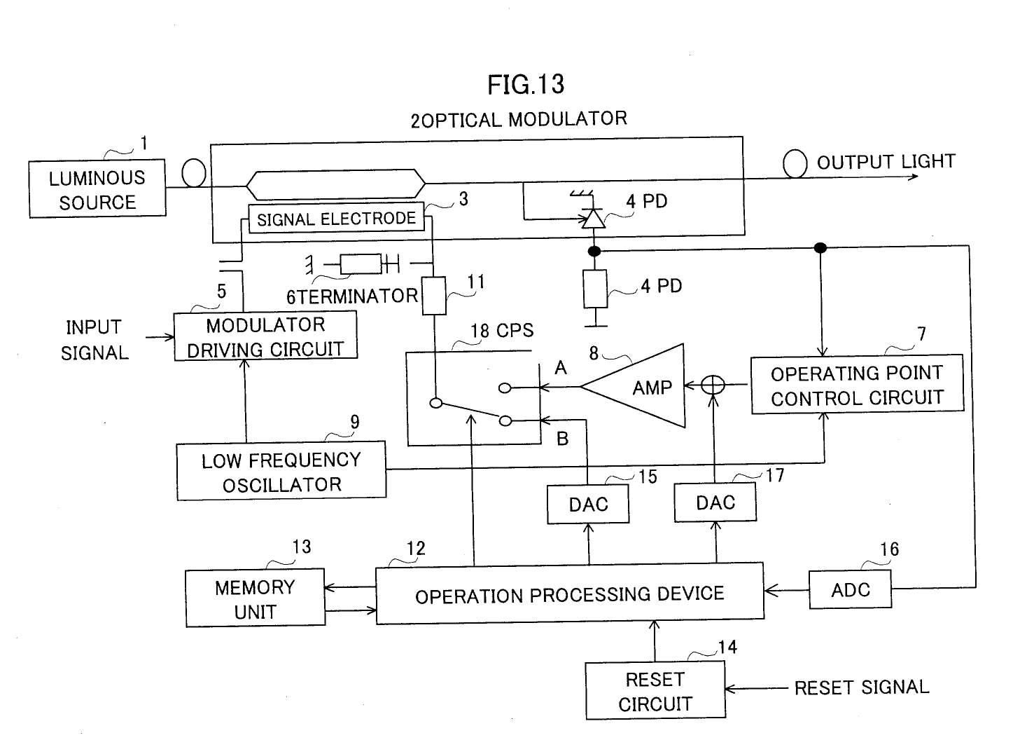

Next, the second embodiment of the present invention is explained with reference to FIG. 13.

FIG. 13 is a block diagram showing the configuration of the optical transmitter of the second embodiment of the present invention. In FIG. 13, the same reference numbers are given to the same elements as the first embodiment. The optical transmitter includes a luminous source 1 that further includes a semiconductor laser, etc., a Mach-Zehnder type optical modulator 2 (the modulator 2), a signal electrode 3, a photo detector (PD) 4, a modulator driving circuit 5, a terminator 6, an operating point control circuit 7, an amplifier for applying a bias voltage AMP, a low frequency oscillator 9, a coil 11 for a bias-tee, an operation processing device 12, such as CPU, a memory unit 13, a reset circuit 14, D/A converters 15 and 17, an A/D converter 16, and a cross point switch CPS 18.

The luminous source 1 provides a constant-intensity light to the modulator 2. The cross point switch CPS 18 is first set to the B side, as shown in FIG. 13. The operation processing device 12 gives a bias voltage Vbias1 to the signal electrode 3 through the amplifier AMP and the coil 11. Then, the output light having an optical intensity according to the input-and-output characteristics of the modulator 2 is obtained from the modulator 2. The output light is detected by the optical detection circuit 4, and is converted to an electric signal, which, then, is converted to a digital signal by the A/D converter 16, and, as a result, the operation processing device 12 acquires an optical intensity value Pout1 corresponding to the input bias voltage.

Next, the operation processing device 12 gives a bias voltage Vbias2 that is different from the above Vbias1 by dV (volts) to the signal electrode 3, and acquires the optical intensity value Pout2 that corresponds to Vbias2. Similarly, this operation is repeated, and sweeping of the bias voltage point is carried out by the same technique as the first embodiment of the present invention, and the optical intensity values Pout1, Pout2, . . . and Poutn, which correspond to each bias voltage, respectively, are acquired, and stored in the memory unit 13.

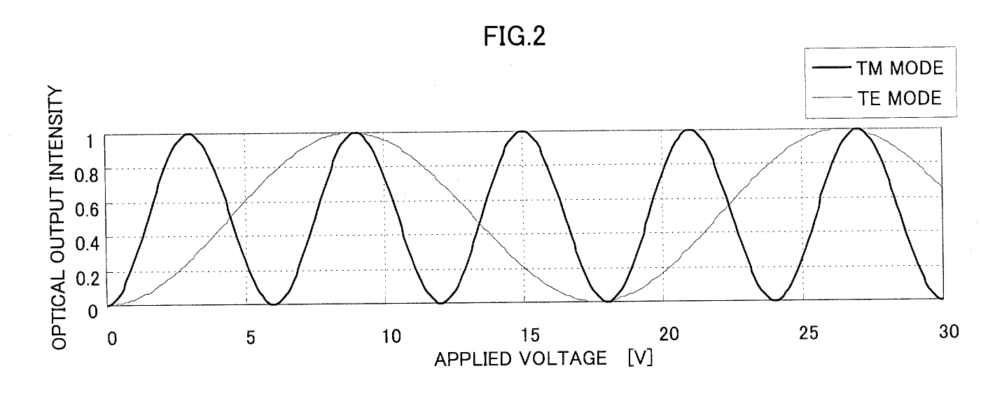

Since the Mach-Zehnder type optical modulator has the characteristic that (Vπ in TM mode)×3 is approximately equal to (Vπ in TE mode) (refer to FIG. 2), the optimal bias voltage point is detectable by measuring three cycles of Vπ in the TM mode. In this manner, the three cycles are made the sweeping range of the bias voltage.

From the input-and-output characteristics acquired in this manner, a bias range between Vbias_l and Vbias_m that gives the largest dynamic range from a range between Pout_{—}1 and Pout_n is selected. The bias range is made the starting point of the feedback control. Then, the CPS 18 is switched to the A side, such that the feedback control loop of the conventional technology is activated.

When the reset circuit 14 detects a predetermined reset signal that is generated upon the power supply starting, switching of the incident light to the modulator, a switching, etc., the reset circuit 14 resets the operation processing device 12 such that the bias voltages are swept, the input-and-output characteristics of the modulator 2 are acquired, and the optimal bias voltage point is obtained as above, again.

Here, the method for selection of the sampling step width for acquiring sufficient accuracy in detection of the input-and-output characteristic is the same as that of the first embodiment.

The characteristics of the optical transmitter are stabilized by the configuration as above described, when the input-and-output characteristics of the modulator are changed due to variation of the polarization angle of the incident light provided to the modulator, the variation being due to the luminous source, the modulator, the fiber connection (splicing) between the luminous source and the modulator, etc. Further, the configuration allows relaxing requirements for the luminous source, the modulator, and the accuracy of splicing, and dispenses with an expensive polarization filter, etc., resulting in cost reduction, miniaturization, etc., of the optical transmitter.

As described above, according to the optical transmitter of the present invention, which includes a Mach-Zehnder type modulator, even if the input-and-output characteristics of the modulator are affected by variation of polarization angle of the incidence light, the bias voltage that gives the optimal range of operation can be determined by scanning the predetermined range of the input-and-output characteristics. The determined bias voltage is used as the starting point in the feedback control, etc., such that the optimal operation range is constantly available, producing the optimal quenching ratio.

Further, the present invention is not limited to these embodiments, but various variations and modifications may be made without departing from the scope of the present invention.

The present application is based on Japanese priority application No.2002-174611 filed on Jun. 14, 2002 with the Japanese Patent Office, the entire contents of which are hereby incorporated by reference.

What is claimed is

1. An optical transmitter, comprising:
a Mach-Zehnder type optical modulator that modulates optical intensity of an incident light by an input modulation signal, and outputs optical modulated signals,
input-and-output characteristic scanning means for scanning a predetermined portion of the input-and-output characteristic of the Mach-Zehnder type optical modulator by changing a bias voltage of the input modulation signal, and
optimal bias voltage point determining means for determining a bias voltage point that gives an optimal dynamic range of the Mach-Zehnder type optical modulator from results of scanning by the input-and-output characteristic scanning means.

2. The optical transmitter as claimed in claim 1, wherein the bias voltage point that gives the optimal dynamic range of the Mach-Zehnder optical modulator is the bias voltage point that makes an operation range in which a quenching ratio is the greatest available, the quenching ratio being a ratio of a peak signal intensity value of the output signal to a bottom signal intensity value of the output signal.

3. The optical transmitter as claimed in claim 1, further comprising operating point control means for controlling the bias voltage point, starting from the bias voltage point that is determined optimal by the optimal bias voltage point determining means, such that the optimal operation range of the modulator is constantly available by adjusting the bias voltage point.

4. The optical transmitter as claimed in claim 1, wherein a scanning range of the input-and-output characteristic, which the input-and-output characteristic scanning means scans, covers three cycles of the input-and-output characteristic when the incident light is in TM mode.

5. The optical transmitter as claimed in claim 1, wherein, when a predetermined reset condition occurs, the input-and-output characteristic scanning means scans the predetermined range of the input-and-output characteristic of the Mach-Zehnder type modulator again, and the optimal bias voltage point determining means determines again a bias voltage point that gives an optimal dynamic range of the Mach-Zehnder type optical modulator from results of the scanning.

6. The optical transmitter as claimed in claim 1, wherein the input-and-output characteristic scanning means scans values of the predetermined range of the input-and-output characteristic in a step, width of which step is selected according to a desired quenching ratio such that the bias voltage point that gives an operation range that provides the desired quenching ratio is obtained.

7. The optical transmitter as claimed in claim 6, wherein the width of the step is made variable according to scanning positions on the input-and-output characteristic of the modulator.

8. The optical transmitter as claimed in claim 1, further comprising switching means for switching between a circuit for input-and-output characteristic scanning operation by the input-and-output characteristic scanning means, and a circuit for controlling operations by the operation range control means that controls the bias voltage point such that the optimal operation range is constantly available by detecting a variation of the operation range of the modulator, the operation range having been determined to be available by the bias voltage point, making the bias voltage point that has been determined optimal by the optimal bias voltage point determining means a starting point.

9. A controlling method of an optical transmitter that comprises a Mach-Zehnder type optical modulator that modulates optical intensity of an incident light by an input modulation signal, and outputs optical modulated signals, comprising:
an input-and-output characteristic scanning step for scanning a predetermined portion of the input-and-output characteristic of the Mach-Zehnder type optical modulator by changing a bias voltage of the input modulation signal, and
an optimal bias voltage point determining step for determining a bias voltage point that gives an optimal dynamic range of the Mach-Zehnder type optical modulator from results obtained by scanning by the input-and-output characteristic scanning step.

10. The controlling method of the optical transmitter, as claimed in claim 9, wherein the bias voltage point that gives the optimal dynamic range of the Mach-Zehnder optical modulator is a bias voltage point that makes an operation range in which a quenching ratio is the greatest available, the quenching ratio being a ratio of a peak signal intensity value of the output signal to a bottom signal intensity value of the output signal.

11. The controlling method of the optical transmitter as claimed in claim 9, further comprising an operating point control step for controlling the bias voltage point, starting from the bias voltage point that is determined optimal by the optimal bias voltage point determining means, such that the optimal operation range of the modulator is constantly available by adjusting the bias voltage point.

12. The controlling method of the optical transmitter as claimed in claim 9, wherein a scanning range of the input-and-output characteristic, which is obtained by the input-and-output characteristic scanning step, covers three cycles of the input-and-output characteristic when the incident light is in TM mode.

13. The controlling method of the optical transmitter as claimed in claim 9, wherein, when a predetermined reset condition occurs, the input-and-output characteristic scanning step scans the predetermined range of the input-and-output characteristic of the Mach-Zehnder type modulator again, and the optimal bias voltage point determining step determines again a bias voltage point that gives an optimal dynamic range of the Mach-Zehnder type optical modulator from results of the scanning.

14. The controlling method of the optical transmitter as claimed in claim 9, wherein the input-and-output characteristic scanning step scans values of the predetermined range of the input-and-output characteristic in a step, width of which step is selected according to a desired quenching ratio such that the bias voltage point that gives an operation range that provides the desired quenching ratio is obtained.

15. The controlling method of the optical transmitter as claimed in claim 14, wherein the width of the step is made variable according to scanning positions on the input-and-output characteristic of the modulator.
